(19) United States
(12) Patent Application Publication
(10) Pub. No.: US 2005/0100712 A1
(43) Pub. Date: May 12, 2005

(54) Polymerization welding and application to microfluidics

(76) Inventors: Blake A. Simmons, San Francisco, CA (US); Robert Crocker, Fremont, CA (US); Paul Michael Dentinger, Sunol, CA (US); Marion Catherine Hunter, Livermore, CA (US); Kamlesh Patel, Dublin, CA (US); Jonathan Sala, Redondo Beach, CA (US)

Correspondence Address: SANDIA CORPORATION, P O BOX 5800, MS-0161, ALBUQUERQUE, NM, 87185-0161, US

(21) Appl. No.: 10/712,808

(22) Filed: Nov. 12, 2003

(51) Int. Cl. B29C 65/00; B32B 31/26

(52) U.S. Cl. 428/172; 264/248; 156/292; 156/307.1

(57) ABSTRACT

Methods and materials are described for the joining of plastics and other materials wherein polymerizable substances are diffused into the material to form a surface diffusion zone adjacent to the surface of the plastic workpiece to be joined. The surfaces are brought into contact and the polymerization reactions in the surface diffusion zone are initiated, creating thereby a strong bond across the contacting surfaces. High-performance engineered plastics such as polyetherimides, polyphenylenes, and polyether-ether-ketones are among the materials that are advantageously joined by this technique. Polymerizable substances including styrene and divinylbenzene are shown to give good bonds. Such joining methods can bond dissimilar materials difficult or impossible to join by other techniques. The surfaces to be joined are dry prior to initiation of the polymerization reaction, permitting repositioning and realignment of the surfaces as often as desired before joining. The present joining techniques do not clog or interfere with the structure of microfeatures on the surface of the workpieces to be joined, making this joining techniques especially advantageous for the fabrication of microfluidic devices. Such devices fabricated from high-performance engineered plastic joined by the present bonding techniques are shown to be capable of routine operation at high pressures and to withstand high-pressure cycling without damage.

### STATEMENT REGARDING FEDERALLY SPONSORED RESEARCH OR DEVELOPMENT

This invention was made with Government support under government contract no. DE-AC04-94AL85000 awarded by the U.S. Department of Energy to Sandia Corporation. The Government has certain rights in the invention, including a paid-up license and the right, in limited circumstances, to require the owner of any patent issuing on this invention to license others on reasonable terms.

### BACKGROUND OF THE INVENTION

1. Field of Invention

This invention relates generally to the field of methods and materials for joining plastics and other substances, and more specifically, to the joining of high-performance thermoplastic resins, to the joining of dissimilar plastics and to the fabrication of microfluidic devices.

2. Description of the Prior Art

There are numerous techniques for bonding or joining polymeric substances. Examples include: adhesives, thermoplastic (hot-melt), reactive (various epoxies, cyanoacrylates and silicones); solutions, emulsions and dispersions (lacquers and cements); solvent, thermal, ultrasonic, pressure sensitive, among others. These techniques typically produce bond strengths substantially less than the structural strength of the substrate material. However, for some polymeric substances and for properly designed joints, it is possible to achieve joint strengths that exceed the structural strength of the substrate materials joined. Such strong joints are typically produced only for properly designed joints and only if excellent interfacial bonds are created between the adhesive and the workpiece (for example, no-slip, iso-strain condition).

However, there are many high-performance engineered plastics or polymers that possess outstanding structural properties for which joining is a challenge. Examples include polyimides (for example, the commercial product VESPEL), polyetherimides (such as ULTEM), polyether-ether-ketones (PEEK) and polyphenylenes (such as NORYL and PARMAX). It is not always possible to design proper joints for such materials or to properly adhere to these materials such that the advantageous bulk properties of the materials can be fully utilized in a joined structure. Thus, there exists a need in the art to adhesively join or “weld” these and other polymers such that the advantageous bulk properties can be utilized in the joined structure.

An emerging technology in which high-performance polymers could have a substantial impact is the field of microfluidics. Microfluidic devices have a broad range of applications for processing chemical and biological samples including mixing, reacting, metering, analyzing, detecting, among others. Many synthetic and analytical techniques can be miniaturized to be performed by means of microfluidic devices that otherwise would require bulky and complicated equipment.

Microfluidic devices are commonly manufactured from glass, silicon or various plastic substrates. However, operation of conventional microfluidic devices is limited to relatively low pressures, typically below about 1,000 psi (pounds-per-square-inch). For operations such as high-performance liquid chromatography (HPLC), it would be desirable to operate at significantly higher pressures. High-performance polymers, such as those noted above, would provide structural advantages and allow operation of microfluidic devices at higher pressures, if such polymers could be joined together into a microfluidic device by joining techniques that withstand high pressures without damage.

Joining high-performance plastics or other polymers into a functioning microfluidic device advantageously calls for carrying out the joining process without clogging or otherwise interfering with the fluid flow through the microfeatures of the device. Many conventional joining techniques involve the addition of an adhesive or other substances that tend to clog microfeatures and disrupt the proper functioning of the device. Other joining techniques can involve disruption of the geometric structure of the microfeatures.

In view of the foregoing, a need exists in the art for procedures and materials to join or weld high-performance and other plastics such that the advantageous bulk properties of such materials can be utilized in the final joined structure, and for processes and materials to produce microfluidic devices without disruption of the microfeatures during joining, and for processes and materials to produce microfluidic devices capable of high-pressure operation.

### SUMMARY OF THE INVENTION

Accordingly and advantageously the present invention relates to methods and materials for bonding plastics and other substances, including dissimilar plastics difficult or impossible to join with other techniques.

Polymerizable substances are typically diffused into a surface diffusion zone adjacent to the surface of a workpiece to be joined. The polymerizable substance can include one or more reactive species as well as inhibitors, stabilizers, catalysts and other materials conveniently included with the polymerizable materials. Two workpieces are brought into contact along the surfaces adjacent to the surface diffusion zone and the polymerization reaction caused to occur. The resulting reaction forms a strong bond across the contacting surfaces. In particular, high-performance engineered plastics can be joined by this “polymerization welding” technique that can be difficult or impossible to join with other techniques.

Polymerization welding does not require a surface diffusion zone in both workpieces to be joined. As demonstrated in the examples included herein, a surface diffusion zone in a single workpiece can be sufficient for the formation of a strong bond.

Polymerization welding can be used to bond dissimilar materials not easily joined by other techniques, so long as polymerizable material can be formed into a surface diffusion zone in at least one workpiece. The polymerizable materials capable of reacting across the contacting surfaces can be the same or different in the two joined workpieces, allowing different diffusion properties to be accounted for in the two workpieces to be joined.

Polymerization welding is a dry bonding process that typically does not clog or interfere with the geometry of any microfeatures present on the surfaces to be joined. Thus, polymerization welding is particularly advantageous for the fabrication of microfluidic devices.

As a dry bonding process, polymerization welding allows the workpieces to be repositioned and realigned numerous times before initiating the polymerization reaction (typically by heating). Thus, unlike many other adhesive bonding techniques, polymerization welding allows the workpieces to be brought into contact and readily repositioned to the precise desired locations, unimpeded by adhesive on the surfaces.

Microfluidic devices fabricated by polymerization welding of high-performance engineered plastics are shown to be capable of high pressure operation, at least up to approximately 9,000 psi. Furthermore, such devices are shown to be capable of withstanding high-pressure cyclic operation, not requiring exposure to a constant pressure.

These and other advantages are achieved in accordance with the present invention as described in detail below.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not to scale.

The techniques of the present invention can readily be understood by considering the following detailed description in conjunction with the accompanying drawings, in which:

FIG. 1 depicts in schematic cross-section: (A) a plastic substrate having polymerizable material on a surface thereof; (B) The formation of a surface diffusion zone and the drying of excess polymerizable material; and (C) A plastic workpiece ready for joining with another workpiece.

FIG. 2 depicts in schematic cross-section: (A) a plastic substrate containing microfeatures and having polymerizable material on a surface thereof; (B) the formation of a surface diffusion zone and the drying of excess polymerizable material; and (C) a plastic workpiece ready for joining with another workpiece.

FIG. 3 depicts in schematic cross-sectional view plastic workpieces in intimate contact for bonding: (A) a workpiece with microfeatures bonded to an unstructured workpiece; (B) the bonding of two workpieces containing microfeatures; (C) the bonding of two unstructured workpieces.

FIG. 4 illustrates in schematic cross-sectional view at a greatly enlarged scale, chemical bonding believed to be formed as a result of polymerization welding between two substrates, each substrate having a surface diffusion zone of polymerizable material formed by deposition and, when needed, drying of excess surface polymerizable material as depicted in FIGS. 1 and 2. Only a portion of a polymerized network is shown.

FIG. 5 illustrates in schematic cross-sectional view at a greatly enlarged scale, chemical bonding believed to be formed as a result of polymerization welding between two substrates, only one of which has a surface diffusion zone of polymerizable material prepared by deposition and, when needed, drying of excess surface polymerizable material as depicted in FIGS. 1 and 2. Only a portion of a polymerized network is shown.

FIG. 6 is an enlarged optical image of microfluidic features in PARMAX-1200, with typical channel depths of approximately 50 μm and widths of approximately 100 μm.

FIG. 7 is an enlarged optical image of a via that has been drilled through the polymer disc of FIG. 6 and into the microfluidic channel, having a tilt angle of approximately 20 degrees.

FIG. 8: (A) Is an enlarged optical image of a polymerization welded channel in a disc of PARMAX-1200; and (B) is a graphical depiction of a pressure test of the device of FIG. 8A demonstrating containment of pressures in excess of 2,500 psi before leakage occurs.

### DETAILED DESCRIPTION

After considering the following description, those skilled in the art will clearly realize that the teachings of the invention can be readily utilized in the joining or bonding of plastics or similar materials. In particular, the joining techniques described herein can be advantageously utilized to join dissimilar plastics, typically difficult to bond by other techniques. Also, the techniques described herein can be advantageously employed in the fabrication of microfluidic devices, particularly microfluidic devices capable of operating at high pressures. We use herein “joining” or “bonding” of plastics or other materials interchangeably and without distinction to denote the fusion of two or more pieces of material, referred to herein as “workpieces.” The particular bonding techniques described herein as “welding” are intended to indicate the addition of one or more materials at the interface to be joined to facilitate the joining process.

Bonding techniques described herein typically include the deposition of one or more reactive or polymerizable materials onto the surface of at least one of the workpieces to be joined and the subsequent diffusion or permeation of these species into the region adjacent to the surface, forming thereby a “surface diffusion zone” containing reactive or polymerizable material. To be succinct, a reactive or polymerizable material is described herein as “polymerizable material, species or substance” without distinction. The movement of the polymerizable substance through the workpiece is referred to as diffusion or permeation without distinction. In particular, many plastic materials are found to provide good diffusion for suitable polymeriazable species deposited on the surface. However, the present invention is not limited to joining plastics and can be used for joining non-plastic materials having suitable porosity to allow sufficient diffusion of the surface-deposited polymerizable species into the bulk of the material. For economy of language, we describe all such materials as “plastic,” understanding thereby that porous non-plastic materials permitting absorption, diffusion, permeation, or the incorporation of surface-deposited polymerizable species are included.

For economy of language, we use “surface diffusion zone” to indicate that region of the workpiece adjacent to the surface to be joined containing the polymerizable material prior to the joining of the workpieces. This region containing polymerizable material is typically and conveniently created by the application of the polymerizable material to the surface of the workpiece to be joined, followed by diffusion through the surface and into the adjacent region. However, embodiments of the present invention typically make use of the polymerizable material in the surface diffusion zone adjacent to the surface to be joined and do not depend on the details of how this zone is created. For example, in addition to diffusion through the surface to be joined, the entire plastic substrate may be immersed in polymerizable material. The workpiece may be initially formed with polymerizable material included therein during the formation process. Diffusion can be assisted by application of proper temperature, pressure, catalysts, or other diffusion-promoting devices. Thus, the “surface diffusion zone” need not be created strictly by diffusion through the surface to be joined, although this is found to be a convenient method for some of the embodiments described herein. Similarly, the surface diffusion zone need not have a minimum or a maximum thickness, merely that sufficient polymerizable material be present near the surfaces to be joined that an adequately strong joint is formed.

It is envisioned that an important field of application for polymerization welding lies in the fabrication of microfluidic devices. Some techniques for the fabrication of microfluidic devices include the formation of channels, holes (“vias”) or other depressed microstructures or microfeatures on the surface of a substantially flat piece of material followed by the bonding of a structured or unstructured, substantially flat piece of material on top of the depressed structures, forming enclosed channels and microstructures. To be concrete in our description, we consider the specific case of the joining of such structured and unstructured materials to form a microfluidic device, understanding thereby that this is by way of illustration and not limitation of the present invention.

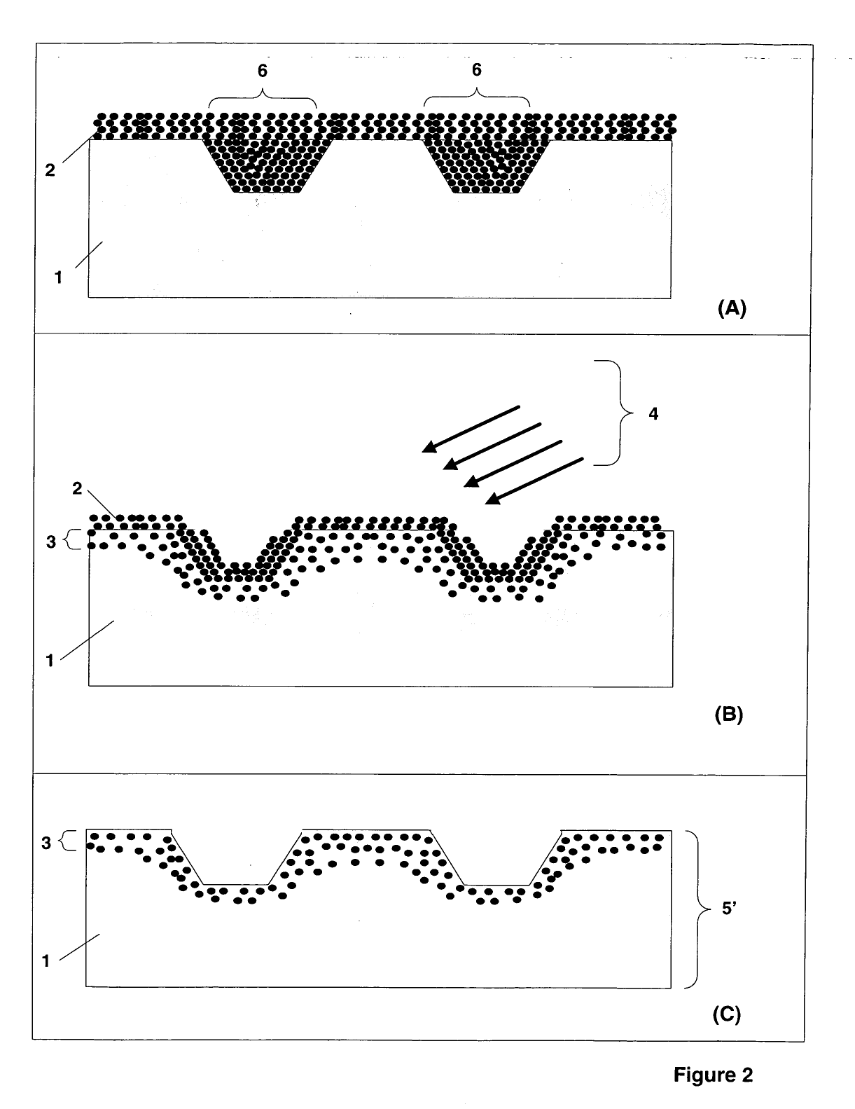

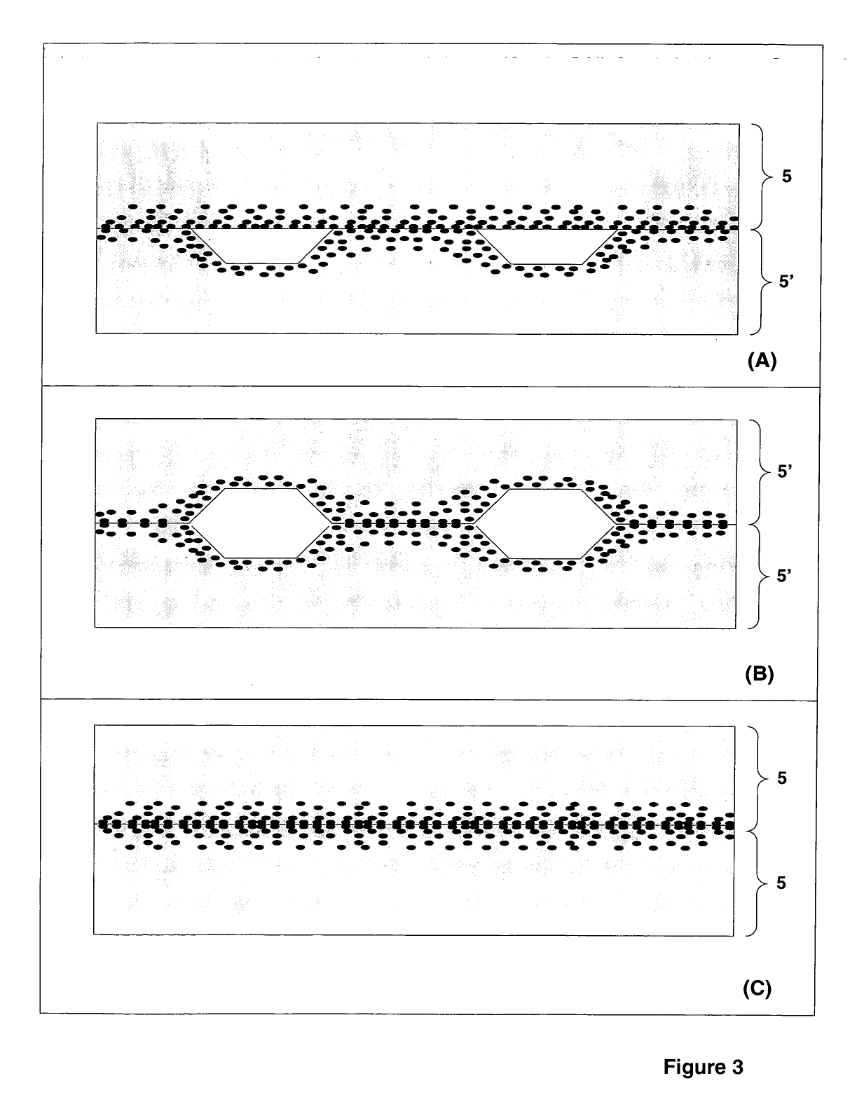

One advantage of polymerization welding over some other joining techniques is that microfeatures on the surface of a workpiece are typically not clogged, blocked or otherwise disturbed by adhesive added during the joining process. This is particularly advantageous in the fabrication of microfluidic devices in which typical microfeatures are intended to carry fluids. However, other types of microfeatures, such as holograms, may also be found on surfaces of workpieces to be joined and would likely be harmed by the collection of extraneous adhesive or other material within its structure. To be concrete in our descriptions, we consider polymerization welding chiefly in connection with particular examples derived from the fabrication of microfluidic devices and the microfeatures typically occurring in such devices. However, it is understood that “microfeature” is not limited to channels, vias or other structures typically occurring in microfluidic devices and, indeed, need not be particularly small in size. “Microfeature” is used herein to describe a general structure on the surface of a workpiece to be joined analogous to those depicted in FIGS. 2 and 3.

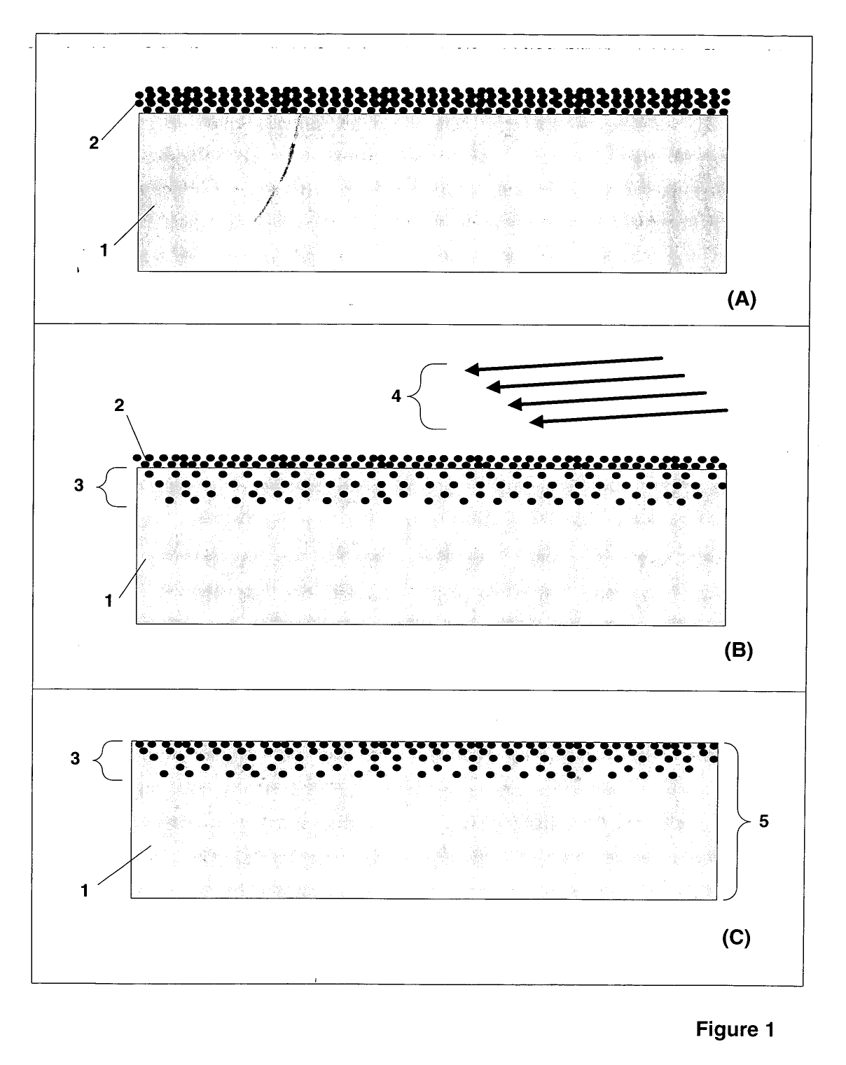

FIG. 1 depicts in schematic cross-section (and not to scale) a typical preparation for polymerization welding of a plastic or other suitably porous substrate 1 pursuant to some embodiments of the present invention. A polymerizable material 2 is typically deposited onto the surface of substrate 1 by spin-coating, wiping, immersion or any convenient means as depicted in FIG. 1A. The polymerizable material 2 can be a single polymerizable chemical species, or a mixture of several polymerizable and other species such as monomers, oligomers, catalysts, among others. In addition, in some embodiments of the present invention it is advantageous for polymerizable material 2 to contain one or more inhibitors to reduce or to prevent premature polymerization.

The combination of substrate 1 and polymerizable material 2 is chosen with a view towards diffusion of material 2 into substrate 1 as depicted schematically in cross-section (not to scale) in FIG. 1B. Material 2 diffuses into substrate 2 to form a layer 3 in proximity to the surface of substrate 1, that is, a surface diffusion zone. Typically, the properties of material 2 and substrate 1 are such that diffusion 3 occurs without assistance. However, this is not an essential limitation. Careful application of temperature, pressure or other environmental conditions can be employed to control the diffusion process within the scope of the present invention.

In some embodiments of the present invention, material 2 will not completely diffuse into the interior of substrate 1, leaving some material 2 on the surface. In such instances, it is advantageous to wipe, dry, or otherwise remove the surface residue. Drying the surface of substrate 1 is typically achieved by an application of a stream of (typically inert) gas, 4, optionally coupled with warming (of gas and/or substrate), reduced pressure or other convenient means to assist in the removal of excess (that is, non-absorbed or non-permeated) surface material 2. The resultant workpiece having a surface diffusion zone and ready for polymerization welding is depicted as 5 in FIG. 1C.

It is envisioned that one important area of application for polymerization welding lies in the fabrication of microfluidic devices. A process similar to that depicted in FIG. 1 can be carried out on a substrate having microfluidic features therein, as depicted in FIG. 2 in schematic cross-section and not to scale. Microfluidic features are depicted as trapezoidal channels 6 in FIG. 2 to be concrete in our depiction. Channels having other shapes, holes or other microfeatures in substrate 1 are within the scope of the present invention.

Coating of a structured substrate (FIG. 2A), diffusion and drying (FIG. 2B), proceed in a manner similar to the flat substrate depicted in FIG. 1 resulting in the structured workpiece 5′ depicted in FIG. 2C. However, in coating and drying the structured substrate of FIG. 2, different coating and/or drying procedures could prove advantageous. One advantage of polymerization welding is that (unlike conventional adhesives) microfeatures on the substrate to be bonded are not filled, encapsulated or clogged with adhesive. Thus, drying to remove polymerizable material 2 from features 6 might call for more stringent drying conditions than that required for a flat substrate depicted in FIG. 1. For example, drying gas 4 might be directed onto the substrate from multiple directions and/or angles, either concurrently or sequentially, in order to facilitate efficient drying. In summary, the processing conditions for a structured substrate depicted in FIG. 2 need not be the same or similar to the processing conditions employed for a substantially flat substrate depicted in FIG. 1.

The substrates are brought into intimate contact as depicted in FIG. 3 and polymerization or similar joining reactions caused to occur. For example, heat may be applied to promote polymerization and joining of the substrates. In cases in which the polymerizable substance contains an inhibitor to reduce or prevent premature polymerization, excess heat applied for sufficient duration can be used to overwhelm the inhibitor and, despite its presence, promote polymerization. Other polymerization schemes can be used in appropriate circumstances. For example, polymerization-promoting radiation, typically ultraviolet, could be usefully applied in certain circumstances, either exposed through a substrate transparent to polymerization-promoting radiation, or applied to the edges of the reaction zone initiating polymerization reactions that propagate throughout the polymerization region.

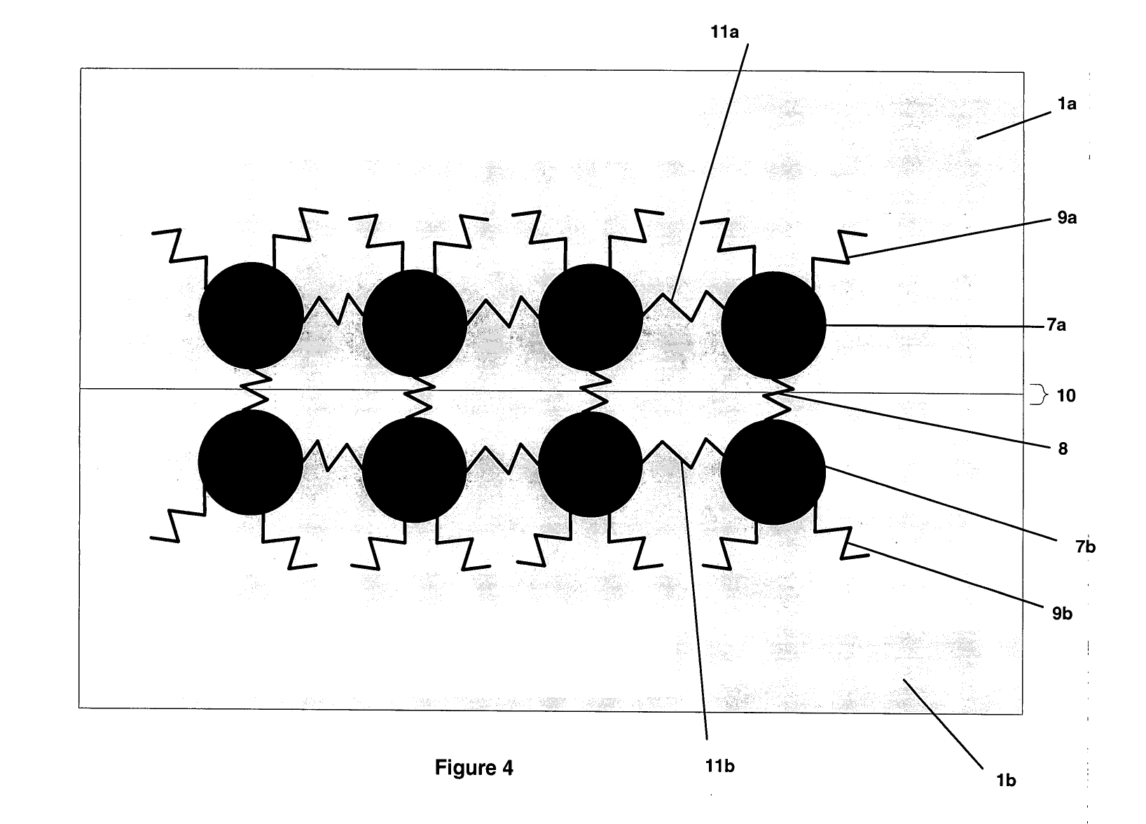

FIG. 4 depicts in schematic cross-section, and greatly magnified view, a qualitative interpretation of typical bonding schemes believed to occur in polymerization welding. Polymerizable molecules 7 are caused to polymerize within the substrate, forming bonds 9 and a polymer network within the substrate, as well as bonding 8 across the interface 10. Molecules 7 need not be a single chemical species but can be a mixture or blend of polymerizable species. In addition, the polymerizable species need not reside entirely within the substrate. The polymerizable species can lie within, partially within or on the surface of the substrate. Thus, the surfaces to be bonded are to be brought into “intimate contact” such that bonding, 8, across the bond plane 10 can occur as depicted schematically in FIG. 4.

The bonds depicted as 9a and 9b in FIG. 4 are intentionally depicted as not joined to any particular molecular species. These bonds 9a, 9b can occur between polymerizable molecules (similar to 11a, 11b), between polymerizable molecules and molecules of the substrate (not depicted in FIG. 4), or a combination of both. Polymerization welding does not depend upon (but does not exclude) the formation of bonds between the polymerizable species and the chemical constituents of the substrate. Polymerization welding of the present invention includes the formation of a network of polymerizable species bonded among itself and interpenetrating (but not necessarily bonded to) the chemical constituents of the substrate. It is found that such interpenetrating networks, within a substrate and across the bond plane to another substrate, can form reasonably good joints to excellent joints without chemically bonding to the constituents of either substrate.

The network depicted in FIG. 4 between polymerizable species (and possibly including bonds to the chemical constituents of the substrate) can have arbitrary spatial extent into the substrate. A portion of such a network is depicted in FIG. 4 with the understanding that the network continues throughout an extended portion of the substrate in a manner analogous to that depicted.

It is envisioned that polymerization welding will typically be performed between workpieces having a surface diffusion zone of polymerizable material created in each workpiece by coating and diffusion of polymerizable materials on and into each workpiece. However, this is not an essential requirement. In some instances (see the examples below) adequate joining can be obtained with a surface diffusion zone created by coating and diffusion of polymerizable materials into only a single substrate of the two to be joined. When this first or “pre-coated” substrate is brought into intimate contact with a second substrate not previously treated with polymerizable material, excellent bonding can still occur.

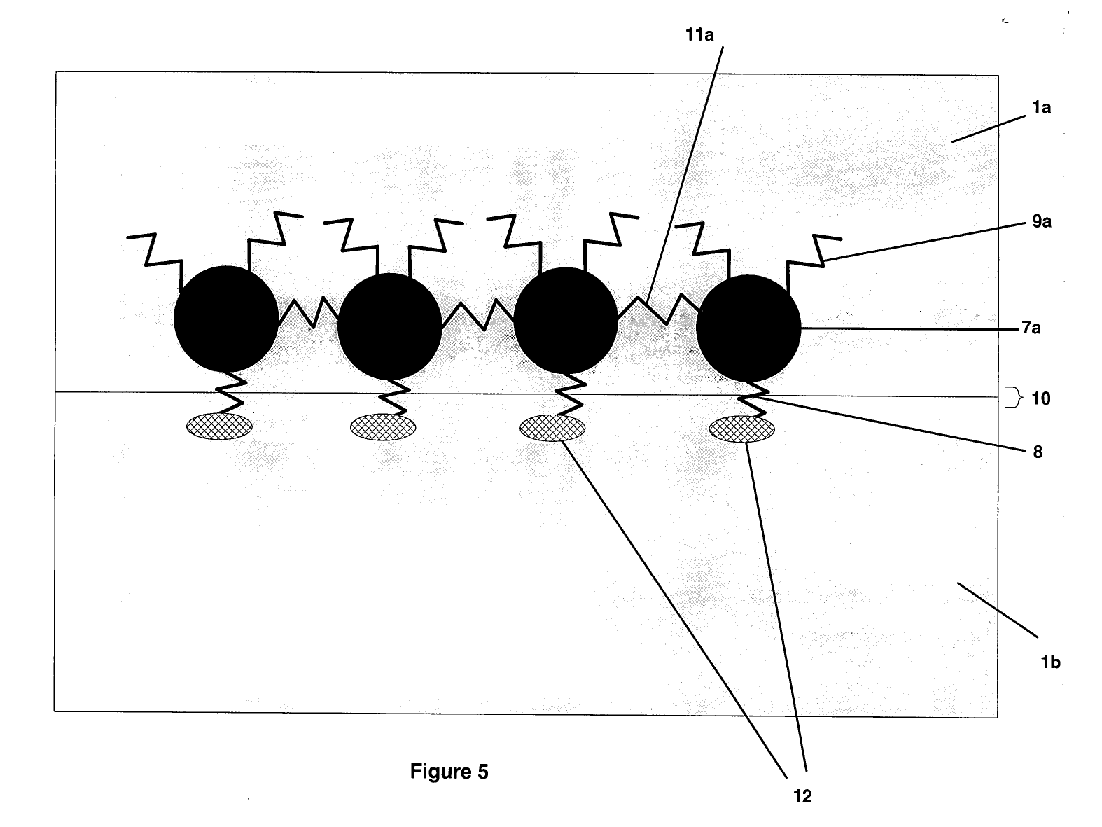

FIG. 5 depicts in schematic cross-section, and greatly magnified view, a qualitative interpretation of bonding believed to occur for polymerization welding between a pre-coated workpiece 1a and a non-pre-coated or “bare” workpiece, 1b. Workpieces 1a and 1b can be the same or different materials. It is believed that the polymerizable material in the surface diffusion zone of the pre-coated workpiece, 7a, or some constituent(s) thereof, diffuse into the surface region of the bare workpiece 1b when 1a and 1b are brought into contact. This out-diffusion from 1a into 1b is believed to create a secondary surface diffusion zone of polymerizable molecules 12, capable of forming bonds 8 across the bond plane 10. In many cases, the polymerizable materials 7a and 12 will be the same, particularly when workpieces 1a and 1b are the same and dissolve the same polymerizable substances. However, this embodiment also includes those cases in which polymerizable substance 7a is a mixture of chemical constituents, some of which more readily out-diffuse from 1a into 1b, providing thereby different compositions for the surface diffusion zones in 1a and 1b, but capable of joining, 8.

FIG. 5 depicts that the formation of bonds between out-diffused species 12 within substrate 1b is an advantageous, but not a necessary feature of polymerization welding. Adequate bonding between workpieces can result when the species lying in one surface diffusion zone react and bond across the interface 10 but not necessarily with each other. Stronger bonds are expected when polymer networks are formed within the workpieces, but non-bonded interpenetration of polymerizable species within the molecular structure of the workpiece can also provide adequate strength of bonding from workpiece to workpiece.

Among the advantages of polymerization welding is the occurrence of, typically, a very thin bond plane 10 resulting from the absence of an adhesive coating on the bonded surfaces. Thus, in applications in which a thin bond plane is desired, polymerization welding could be the joining method of choice.

Polymerization welding is conveniently employed for the joining of the same or similar substrate materials, 1a and 1b. For such cases, procedures leading to the creation of a surface diffusion zone containing a polymerizable material in one substrate can typically also be employed for the second substrate. However, polymerization welding is not limited to joining the same or similar materials nor to the use of the same polymerizable material in each workpiece. A significant advantage of polymerization welding lies in its ability to join dissimilar materials 1a and 1b with a strong bond, when such materials may be difficult or impossible to join with other techniques.

The diffusion and solubility properties of the dissimilar materials may permit surface diffusion zones to be formed including the same polymerizable materials in each substrate despite the substrate materials' dissimilarity. However, in other cases, different blends, formulations or chemical species might be included in different polymerizable materials within the surface diffusion of each substrate. Nevertheless polymerizable materials chosen to form surface diffusion zones in dissimilar substrates may indeed react between themselves to form bonds 8 joining the materials. Thus, when creating surface diffusion zones of polymerizable material in both workpieces to be joined, the polymerizable species can be the same or different on the two sides of bond plane. That is, the polymerizable species 7a and 7b lying in substrates 1a and 1b may be the same or different so long as adequate bonding occurs across the interface 10.

### EXAMPLES

A useful guideline in selecting candidate polymerizable materials is that monomers typically diffuse into and form surface diffusion zones in plastics deriving from the monomer. For example:

TABLE I

| Plastic | Candidate Polymerizable Materials |
|---|---|
| Polymethylmethacrylates | methacrylates, acrylates, etc. |
| Perfluoro plastics | fluorocarbons |
| (e.g., TEFLON)) | hydrocarbons |
| | chlorocarbons |
| | chlorofluorocarbons, etc |
| polyvinylchlorides | vinyl chloride, etc. |
| polystyrene | styrene, substituted styrenes, |
| | vinyltoluene, divinylbenzene, |
| | etc. |

Use of a monomer in cooperation with a plastic deriving from that monomer is not a strict rule in that other polymerizable materials can be found with useful diffusion and solubility properties, not related to the monomer from which the plastic derives. Polymerizable materials that “swell” the plastic are other good candidates in that swelling of the plastic is a useful (but not perfect) indicator of adequate diffusion and formation of a surface diffusion zone.

Not every monomer performs well in cooperation with its associated plastic. However, this rule is found to be a useful guideline for experimentation. In particular, certain modern high-performance engineered plastics have been found to be particularly advantageous for forming microfluidic and other structures by polymerization welding. Examples include strong and stiff thermoplastics derived from substituted poly(1,4-phenylene) in which each phenylene ring may have a substituent derived from a wide variety of organic groups. All such compounds are denoted herein as “polyphenylenes” for economy of language. Various polyphenylene derivatives are commercially available under the tradename PARMAX or PARMAX Self-Reinforced Polymers. PARMAX-1000 includes benzoyl substituted 1,4-phenylene units and PARMAX-1200 contains both benzoyl substituted 1,4-phenylene units and unsubstituted 1,4-phenylene units. PARMAX-1000 and PARMAX-1200 are conveniently available commercial grades of PARMAX, used in the examples given herein. Unless otherwise specified, “PARMAX” will denote PARMAX-1200.

Other useful high-performance engineered plastics amenable to polymerization welding include amorphous thermoplastic polyetherimides offering good heat resistance, high strength and broad chemical resistance. Examples of such polyetherimides are commercially available under the tradename ULTEM. In particular, the commercial product ULTEM-1010R is advantageously joined by means of polymerization welding as described in the following examples.

Yet another class of high-performance engineered plastics advantageously joined by means of polymerization welding are polyetherketones, typically offering high strength and chemical resistance and commercially available under the tradename PEEK.

A solution was prepared comprising styrene and divinylbenzene (DVB) in a ratio of approximately 9:1 styrene:DVB by volume. We denote this polymerizable material as “Solution A”. DVB is found to be a convenient cross-linking monomer for polymerization welding.

In the examples of polymerization welding described herein, the workpieces were typically pre-cleaned by multiple washings in a solvent and dried before exposure to the polymerizable material. PARMAX was conveniently pre-cleaned with acetone and ULTEM pre-cleaned with methanol, although other solvents can be employed as well.

### Example 1

Two samples of ULTEM-1010R were soaked in Solution A for approximately 10 minutes at room temperature. No separate drying step was used for removing excess polymerizable material from the surface of the workpieces. The ULTEM workpieces were then pressed together under a load of approximately 400 psi (pounds-per-square-inch). The temperature was elevated to approximately 230 deg. F. and maintained at that level for approximately 3 hours. An excellent polymerization weld was produced.

Although 230 deg. F. seems to be close to optimal for the samples studied in Example 1, a range of temperatures from approximately 170 deg. F. to approximately 230 deg. F. should also give adequate bonding. Commercially available monomers, such as those used in preparing Solution A, are commonly delivered with inhibitors present to prevent unwanted or premature polymerization. Therefore, higher temperatures are typically required to swamp the inhibitors and produce good bonds between the workpieces. Other solutions prepared without inhibitors would be expected to produce polymerization welding at substantially lower temperatures. In summary, the temperature for achieving adequate polymerization welding is typically a processing parameter that can be determined with a small amount of routine testing for the particular materials employed.

### Example 2

Two samples of PARMAX-1200 were soaked in Solution A for approximately 18 hours at room temperature. Excess solution was removed from the surface of the PARMAX samples. Many drying procedures could be used such as evaporation, draining, spinning, among others. However, in this case it was convenient to flow a dry, inert gas (e.g., argon) over the surface to remove excess Solution A. The workpieces were brought into intimate contact at approximately 400 psi, at a temperature of approximately 230 deg. F. for approximately 18 hours. An excellent polymerization weld was produced.

### Example 3

A microfluidic device was constructed from PARMAX following the procedures of Example 2 and having microchannels therein. Typical microchannels used in this example were approximately rectangular in cross-section and approximately 300 μm wide and approximately 100 μm to 150 μm deep (μm=micron=10 ⁻⁶ meter). Hydrostatic pressure in excess of 9,000 psi was applied to the channels. The seal produced by polymerization welding of PARMAX maintained a water-tight seal and unimpeded flow, even under this high pressure.

### Example 4

A potentially important application for polymerization welding is to join dissimilar plastics, difficult or impossible to join by other techniques. For example, PARMAX and ULTEM were successfully joined by:

1) Soaking the PARMAX workpiece in pure styrene (100% monomer) for approximately 4 hours at room temperature.

2) Removing the PARMAX from the styrene solution, drying and placing in contact with an ULTEM workpiece. The ULTEM workpiece was not pre-treated with polymerizable material.

3) Applying pressure of approximately 400 psi and heating the PARMAX-ULTEM assembly to approximately 230 deg. F., conveniently by means of a Carver press.

4) Holding the applied temperature and pressure for approximately 18 hours forming thereby a polymerization weld joining PARMAX and ULTEM.

Another potentially important area of application for polymerization welding is the fabrication of microfluidic devices, in which conventional bonding techniques commonly clog or otherwise interfere with fluid flow through the device, and high pressure operation would be desirable. For example, microfeatures are typically created on the surface of a plastic sample by any of numerous techniques including reactive ion etching, plasma etching, injection molding, hot embossing, laser machining, micromachining, among others. One or more workpieces containing such microfeatures can then be joined into a microfluidic device by means of polymerization welding.

### Example 5

A high-pressure microfluidic device is fabricated from a high-performance engineered plastic. PARMAX-1200 is used in this example, but it is believed that other high-performance engineered plastics or thermoplastic resins could be used as well.

Initially, microfluidic features are replicated into the polymeric substrate using hot embossing. A Ni tool is formed by electroplating into a glass wafer master. This tool is then used as the replicating surface and is placed into the hot embossing apparatus (such as a heated Carver press). A PARMAX disc is also placed into the embossing apparatus and both disc and tool are held in place by a mechanical chuck. A temperature of approximately 230 deg. F. and a pressure of approximately 400 psi are applied causing the features to be stamped into the polymer disc.

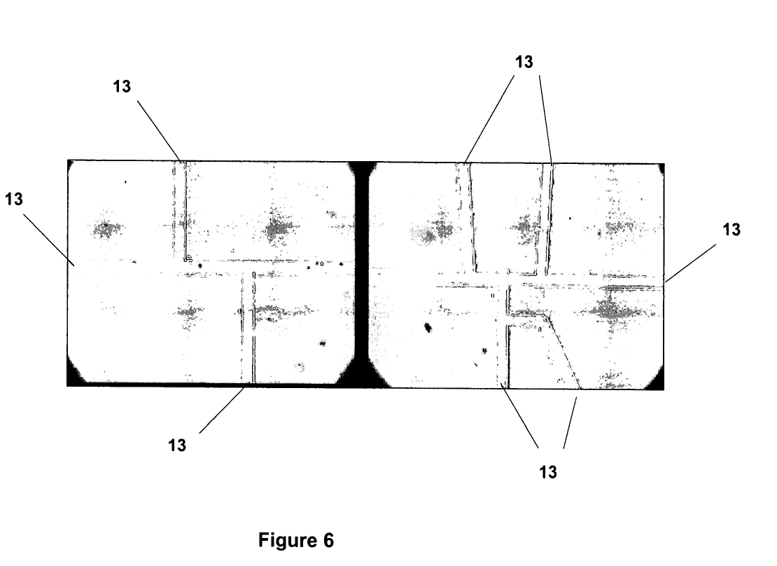

FIG. 6 is a micrograph of microfluidic features replicated in a PARMAX-1200 polymer. Channels 13 have typical depths of approximately 50 μm and typical widths of approximately 100 μm. It is observed that these features are replicated with a high degree of fidelity and are true to the Ni tool in terms of height and depth profiles.

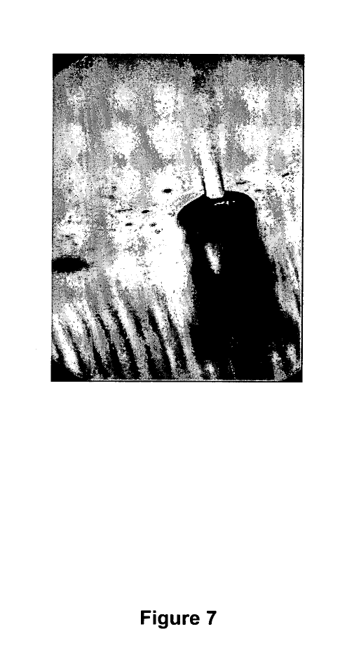

In order for these replicated microfluidic features to be used in an operational device, there must be paths for a fluid (liquid or gas) to flow into and out of this device. A drill press using a drill bit approximately 360 μm in diameter was used to drill these fluidic interconnects or “vias” into the polymer disc directly into the microfluidic channels. A combination of low speed drilling (approximately 400 rpm) and use of a cutting fluid has been found to give good results in terms of low burring, low melting of the polymer surface and avoidance of channel blockage. FIG. 7 is the optical image of a via drilled through the polymer disc to the microfluidic channel at a tilt angle of approximately 20 degrees.

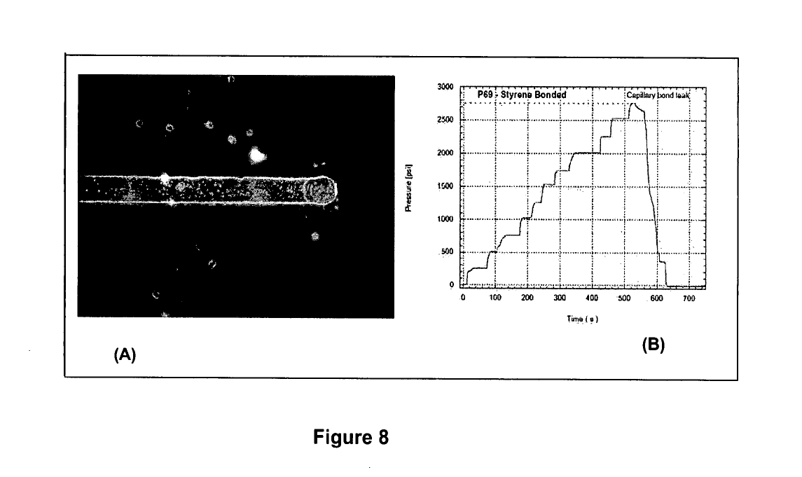

Current state-of-the-art microfluidic devices typically operate at relatively low pressures, often below about 1,000 psi. Some applications, such as HPLC, advantageously operate at considerably higher pressures, for example, at or above approximately 2,000 psi. FIG. 8A is an enlarged optical image of a microfluidic structure in PARMAX-1200 polymerization welded with pure styrene at a temperature of approximately 230 deg. F. and pressure of approximately 400 psi. FIG. 8B demonstrates the ability of this structure to withstand pressures in excess of 2,500 psi without failure.

High-pressure microfluidic devices fabricated pursuant to the examples herein have been demonstrated to be able to withstand high pressure. In addition, the devices can typically withstand numerous cycles of application of high-pressure, demonstrating robustness as well as strength. For example, the device of Example 5 (PARMAX) has been shown to be able to withstand cyclic application of pressures from approximately 1,000 psi to approximately 5,000 psi over a period of approximately 90 minutes.

Polymerization welding is essentially a dry bonding process. That is, the workpieces to be joined are brought into contact along dry surfaces. This offers the advantage of allowing the surfaces to be repositioned numerous times until the alignment is precisely as desired, and only then clamping the workpieces and applying the heat (or other initiating means) as required to initiate polymerization welding.

Although various embodiments which incorporate the teachings of the present invention have been shown and described in detail herein, those skilled in the art can readily devise many other varied embodiments that still incorporate these teachings.

1. A method of joining plastics comprising:
a) creating a first surface diffusion zone containing therein a first polymerizable material, wherein said first surface diffusion zone is adjacent to a first surface of a first workpiece; and,
b) creating a second surface diffusion zone containing therein a second polymerizable material, wherein said second surface diffusion zone is adjacent to a second surface of a second workpiece, and wherein said first polymerizable material and said second polymerizable material are capable of bonding with each other; and,
c) bringing said first surface and said second surface into intimate contact at a bonding surface; and,
d) causing said first polymerizable material and said second polymerizable material to react and join across said bonding surface.

2. A method of joining plastics as in claim 1 wherein at least one of said first surface or said second surface has at least one microfeature therein.

3. A method of joining plastics as in claim 1 wherein at least one of said first workpiece or said second workpiece is a high-performance engineered plastic.

4. A method of joining plastics as in claim 3 wherein at least one of said first workpiece or said second workpiece is selected from the group consisting of polyetherimides, polyphenylenes, and polyether-ether-ketones.

5. A method of joining plastics as in claim 4 wherein said first workpiece and said second workpiece are polyphenylenes and said first polymerizable material and second polymerizable material are mixtures of styrene and divinylbenzene.

6. A method of joining plastics as in claim 5 wherein both of said mixtures have a ratio of approximately 9:1 by volume of styrene to divinylbenzene.

7. A method of joining plastics comprising:
a) creating a first surface diffusion zone containing therein a polymerizable material, wherein said first surface diffusion zone is adjacent to a first joining surface of a first workpiece; and,
b) providing a second workpiece having a second joining surface; and,
c) bringing said first joining surface and said second joining surface into intimate contact at a bonding surface; and,
d) causing said polymerizable material to react and join across said bonding surface.

8. A method of joining plastics as in claim 7 wherein at least one of said first joining surface or said second joining surface has at least one microfeature therein.

9. A method of joining plastics as in claim 7 wherein at least one of said first workpiece or said second workpiece is a high-performance engineered plastic.

10. A method of joining plastics as in claim 9 wherein at least one of said first workpiece or said second workpiece is selected from the group consisting of polyetherimides, polyphenylenes, and polyether-ether-ketones.

11. A method of joining plastics as in claim 10 wherein said first workpiece is a polyphenylene, said second workpiece is a polyetherimide and said polymerizable material is styrene.

12. A material comprising a plastic workpiece in combination with a polymerizable material wherein said polymerizable material is located in a surface diffusion zone adjacent to a surface of said plastic workpiece.

13. A material as in claim 12 wherein said surface of said plastic workpiece has at least one microfeature therein.

14. A material as in claim 12 wherein said plastic workpiece is a high-performance engineered plastic.

15. A material as in claim 14 wherein said plastic workpiece is selected from the group consisting of polyetherimides, polyphenylenes, and polyether-ether-ketones.

16. A material as in claim 15 wherein said workpiece is a polyphenylene and said polymerizable material is selected from the group consisting of styrene and mixtures of styrene and divinylbenzene.

17. A microfluidic device comprising at least one high-performance engineered plastic component joined by the method of claim 1.

18. A microfluidic device as in claim 17 wherein at least one of said high-performance engineered plastic components is selected from the group consisting of polyetherimides, polyphenylenes, and polyether-ether-ketones.

19. A microfluidic device as in claim 18 wherein at least one of said high-performance engineered plastic component is a polyphenylene.

20. A microfluidic device comprising at least one high-performance engineered plastic component joined by the method of claim 7.

21. A microfluidic device as in claim 20 wherein at least one of said high-performance engineered plastic components is selected from the group consisting of polyetherimides, polyphenylenes, and polyether-ether-ketones.
